(19) United States
(12) Patent Application Publication
(10) Pub. No.: US 2013/0160111 A1
(43) Pub. Date: Jun. 20, 2013

(54) Device and Method for Use of Real-Time Biometric Data To Control Content and Device Access

(71) Applicant: Stephen J. Orr, Markham (CA)

(72) Inventor: Stephen J. Orr, Markham (CA)

(73) Assignee: ATI TECHNOLOGIES, ULC, Markham (CA)

(21) Appl. No.: 13/329,626

(22) Filed: Dec. 19, 2011

(51) Int. Cl. G06F 21/00

(52) U.S. Cl. 726/19

(57) ABSTRACT

A device and method for unobtrusively conducting security access checks via biometric data. The device and method obtains biometric data in response to a request for content and initiates a security clearance process that is substantially unobservable to an individual with clearance to access the requested content.

### FIELD OF THE DISCLOSURE

The present disclosure is related to automated methods and devices for controlling content using real-time biometric data.

### BACKGROUND

In computing, including the tablet space, there is a focus on ease of use including use of either automatic or extremely intuitive device behaviors. One example of automatic behaviors includes things like display rotation based on the built in orientation sensors.

Tablets, one kind of computing device, are designed to be very sharable devices that get handed around, left on coffee tables, or are otherwise viewable by individuals other than their owners. This is presents a low security usage model. As tablets progress to being “enterprise” ready, thereby expecting increasingly sensitive data thereon, layers of security are being added. Such security features have the potential to run afoul of the ease of use that has at least partially driven their success.

Also, tablet devices are known that employ an accelerometer which detects motion such that when the tablet is picked up from a table and motion is detected, the current user that is logged on is again allowed access. The user stays logged in but the device can shut off when the user sets the tablet down or if there is no more movement detected. However, the user is still logged into the account. When others pass the device or others can also see the contents of the device so that security can be readily breached.

Accordingly, there exists a need for an improved method and apparatus that automates increased security functionality in a way that does not interfere with the ease of use and automatic behaviors. Additionally, there exists a need for an improved method and apparatus that automates increased security functionality in a way that is itself easy to use and presented in an intuitive way.

### BRIEF DESCRIPTION OF THE DRAWINGS

FIG. 1 is a diagrammatic view of a computing entity employed in accordance with an embodiment of the present disclosure;

FIG. 2 is a flowchart showing a process employed by the computing entity of FIG. 1 in accordance with an embodiment of the present disclosure;

FIG. 3 is a diagrammatic view of hardware and software interaction between parts of the computing entity of FIG. 1; and

FIG. 4 is an exemplary diagrammatic view of the content of a content access control user profile used with the computing entity of FIG. 1.

### DETAILED DESCRIPTION

Briefly, in one example, a method is provided for providing content on a device. The method includes detecting a content request on the device, in response to the content request, determining which of a plurality of users is a current user of the device based on at least one of a visual and audio recognition process carried out by the device, and allowing access to the requested content or restricting access to the requested content in response to the visual or audio recognition process that determines the current user.

In another example, a content presentation device is provided. The device includes a processor; a display; and memory. The memory storing software thereon, that when invoked by the processor cause the processor to: detect a content request on the device; determine, in response to the content request, which of a plurality of users is a current user of the device based on at least one of a visual and audio recognition process carried out by the device; and allow access to the requested content or restricting access to the requested content in response to the visual or audio recognition process that determines the current user.

In yet another example, a method is provided for providing content on a device. The method includes: logging a first user into the device; post log-in of the first user, and in response to a request for content, performing at least one of a visual or audio recognition process on a current user of the device; and preventing displaying of the content on the device in response to determining that the current user is different from the first user, the determining being based on the post-log-in visual or audio recognition process performed on the current user of the device.

Among other advantages, for example, the method and device provide for automatic, continual, intuitive content access control. Access control is achieved without overt specific request by a user to invoke the access control. Continual access control is achieved without requiring repeated logins by the user. Continual access control is achieved without continual perception by the user. The method also provides the advantage that user specific and user appropriate content can be automatically provided to the user without a distinct user-perceptible login event. Also, while preventing undesired content access, the method provides for allowing deliberate sharing of content by an authorized user to a second user. This sharing is achieved without giving the second user access to content beyond what was specifically deliberately shared. Furthermore, the present method provides for security while a user remains logged in. A user is not required to log out in order to prevent unauthorized access. Accordingly, faster access for authorized users is also provided by not requiring user input into an access protocol at every request for access. The present method also provides content specific granularity with respect to the access controls. The same application may be available to all users, but only specific content within that application will be available to certain users.

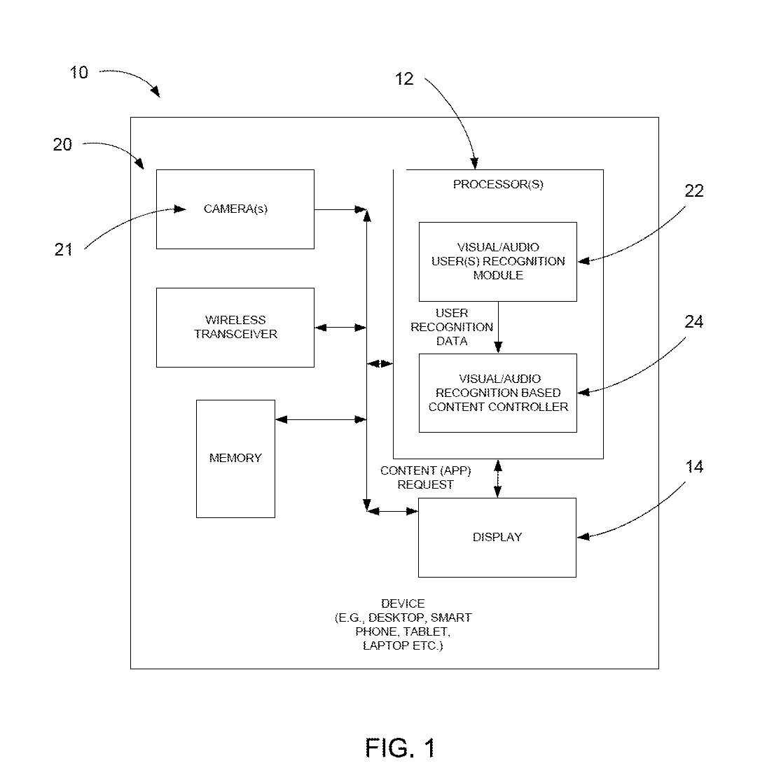

Turning now to the drawings wherein like numerals represent like components, FIG. 1 is a diagram of a device 10 that provides for automated, continual, and seamless implementation of content security. Device 10 includes one or more processors 12, display 14, memory 16, communications device 18, and one or more biometric data sensor 20, shown as camera 21.

Device 10 is illustratively a tablet computing device, such as an iPad. While device 10 is discussed herein as a tablet, embodiments are also envisioned where device 10 is a laptop computer, a desktop computer, a phone, a TV, or other content delivery device capable of receiving biometric information.

Display 14 is illustratively a touch screen such that it also operates as an input for device 10. Communications device 18 is shown as a wireless transceiver for communicating over Wi-Fi, cell networks, or otherwise. While communications device 18 is shown as being a wireless transceiver, embodiments are envisioned where the communications device provides for wired communication.

Memory 16 stores applications, data used by the applications, and an operating system all of which are considered “content.” Camera 21 is located such that it is able to capture image(s) of a user attempting to access content on device 10. Embodiments are envisioned where multiple cameras 21 are used. Such multi-camera embodiments potentially allow for multiple pictures to be taken from multiple angles, thereby increasing the sophistication of the biometric signature that can be detected as known in the art. Additionally, embodiments are envisioned where camera 21 is not integrated into device 10, but rather is an attachable peripheral. Furthermore, while camera 21 is provided as biometric data sensor 20, embodiments are envisioned where other biometric data sensors are used. Such other embodiments include, but are not limited to, microphones and hand or fingerprint scanners.

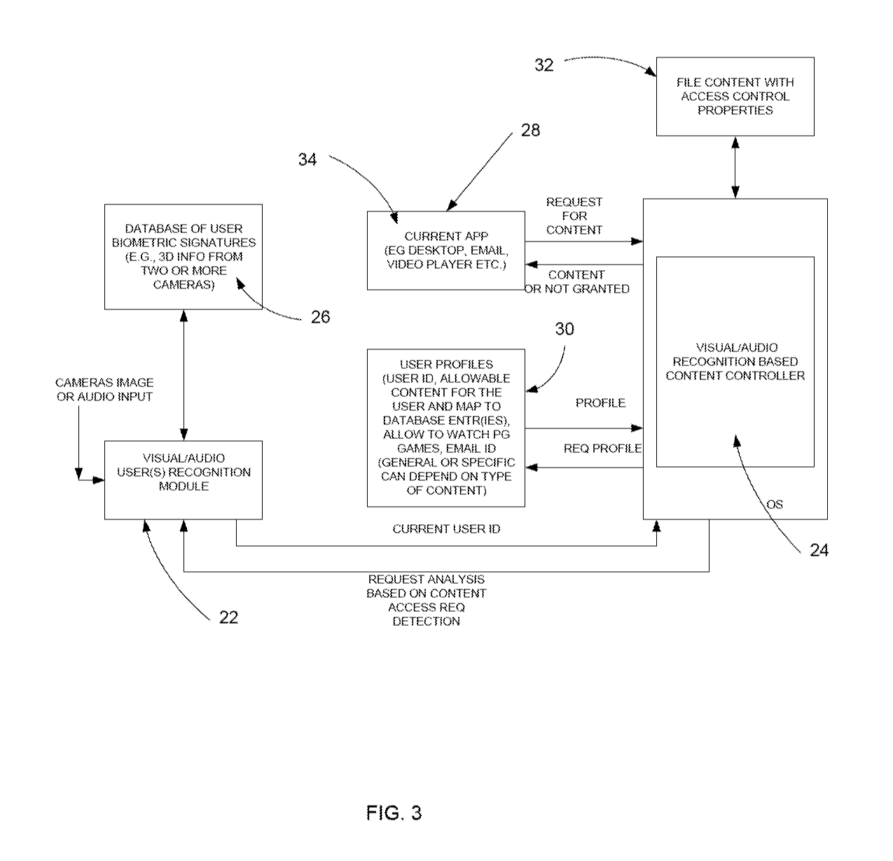

Device 10 further includes user recognition module 22 and content controller 24. Each of recognition module 22 and content controller are described herein as software modules. However, embodiments are envisioned where the functionality of user recognition module 22 and content controller 24 are provided by dedicated hardware pieces. User recognition module 22 receives data from biometric data sensor 20 to determine an identity of a user. User recognition module 22 takes the provided biometric data and processes it to generate a biometric signature of the user. In one embodiment, the biometric signature is generated according to an algorithmic analysis of the biometric data. User recognition module 22 then accesses a database of biometric signatures 26. (FIG. 3). Device 10 then attempts to find a profile stored in database 26 to which the detected biometric signature is linked. If no such linked profile is found, the user is offered at least one of the opportunity to create a profile, or to append or link the current user to an existing profile the opportunity to operate under a “guest” account. Alternatively, embodiments are envisioned where the failure to find a linked profile does not allow creation or appending to a profile which results in blocking of all secured content.

Profile creation is invoked for new users. Appending and linking are invoked for instances where new biometric signatures are presented for existing users. New biometric signatures can result from an audio based signature being added to a profile that previously had only a visual based signature. New biometric signatures can also result from a significant change in visual appearance, such as a man growing or removing facial hair or otherwise. Such creation or addition of biometric signatures may involve the input of a password or other validation means to allow the linking of the biometric signature with a profile.

User recognition module 22 then passes profile identification information to content controller 24. In one embodiment, profile identification information is a unique user ID. In another embodiment, profile identification information is a security profile that lists in detail access privileges of the identified user. Content controller 24 receives profile identification information and uses the profile identification information to determine whether the current user has access privileges to the desired content.

In embodiments where profile identification information is a unique user ID, content controller 24 accesses a permissions database to determine what content the user is allowed to access. In another embodiment, the content itself may have an embedded listing of user ID's that are allowed to access it.

Access can be processed at a number of levels such as device 10, application 28, application profile 34, and information (file) 32. Device level permissions determine whether a user is permitted to use device 10 at all. Application level permissions determine whether a user is permitted to use an application. Application profile permissions determine a user's profile within an application, such as an e-mail application specifying the user's account(s). Information level permissions include document level permissions. By way of example, information (file) level 32 and application level 28 can be tied to parental control type interactions.

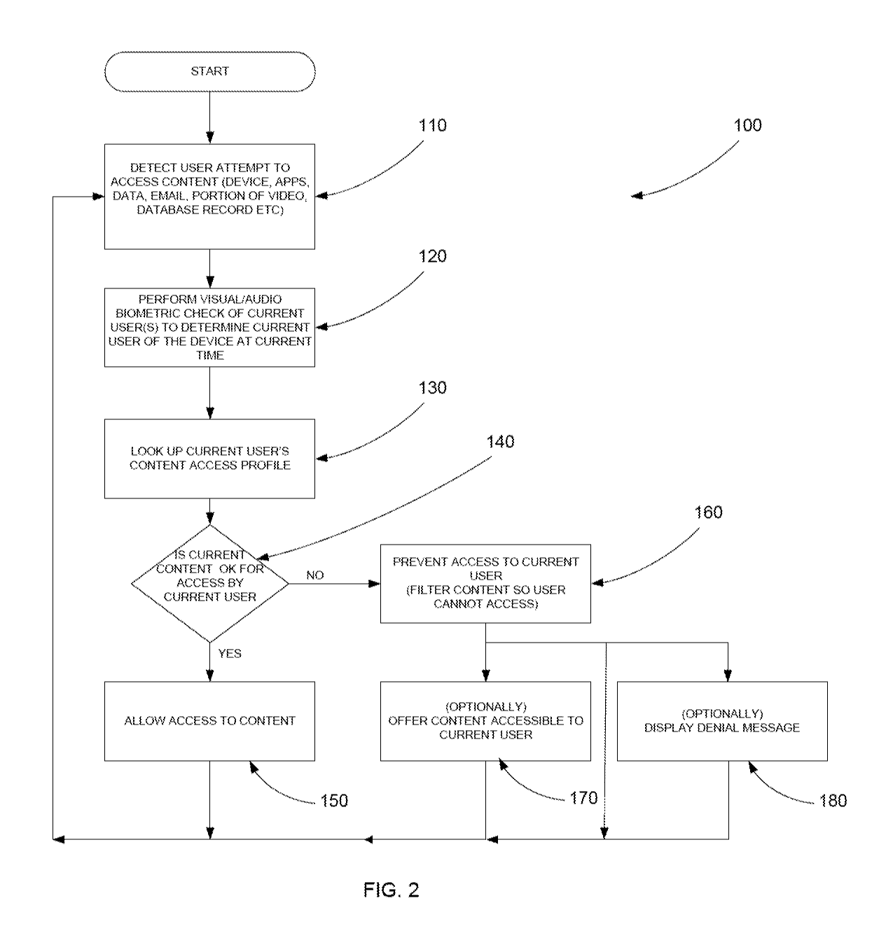

Operation of device 10 will now be discussed with reference to the flowchart of FIG. 2 and the diagram of FIG. 3. Access control 100 is initiated through a request or attempt by a user to access some type of content. Access control 100 is discussed herein as being present at every level (device, application, profile, information (file)). However, security can be selectively implemented at each of the levels as desired.

The first point of security is to check whether the current user is authorized to use device 10. Upon detecting a user attempt to access device 10, step 110, device 10 through content controller 24, initiates a biometric check of the current user, step 120. In the present example, content controller 24 sends a request for analysis to user recognition module 22. User recognition module 22 controls camera 21 or otherwise arranges for biometric data to be received. User recognition module 22 processes the received biometric data to provide user identification information. This information is then compared to entries in database 26 to determine a user ID, step 130. This user ID is then passed back to content controller 24. Alternatively, if the submitted user identification information does not match up with a user ID in database 26, this fact is reported to content controller 24.

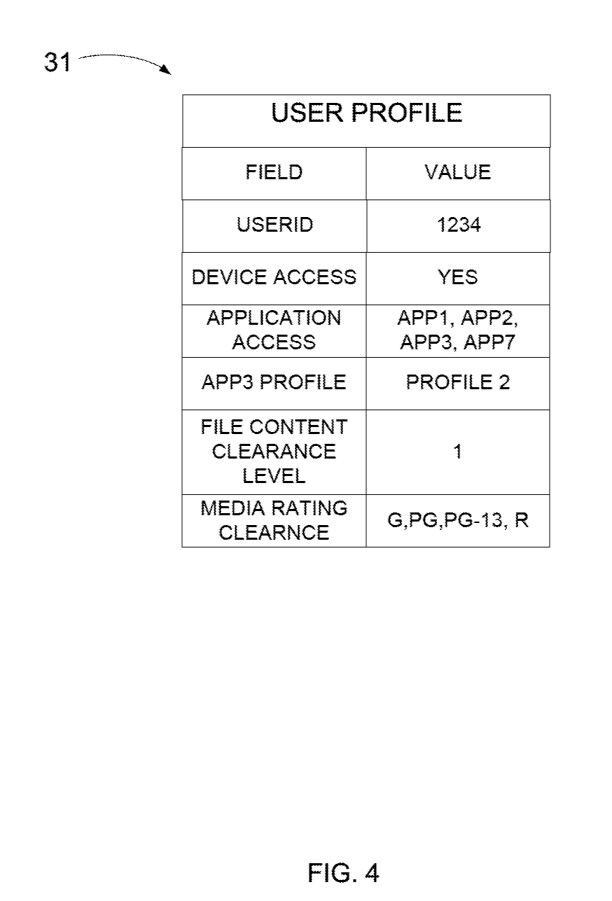

Content controller 24 queries permissions database 30 with the user ID (or lack of a user ID) to request the user's profile to determine whether the current user is authorized to use device 10, step 140. A user profile 31, see FIG. 4, associated with the user ID is found, if any, and used to determine whether a user is authorized to access the requested content. If the user is authorized, the user is granted access to device 10, step 150. If the user is not authorized, content controller 24 prevents access to device 10, step 160. Optionally, a message is displayed indicating that the user is not authorized, step 180. An alternative message is envisioned for the case where biometric sensor 20 is unable to perceive biometric data from a user, such as the user not being in the view of camera 21, instructing the user to adjust device 10 to allow capturing of the biometric data.

Accordingly, in the case of the authorized user, the user has obtained device 10, attempted to access device 10, and through a process that is almost completely undetectable to the user, been granted access to device 10.

The authorized user continues use of device 10 by attempting to access application 28. Again, device 10 detects that the user is attempting to access content, step 110. Content controller 24 is again invoked and performs a biometric check, step 120, through a request to recognition module 22, collection of biometric data, querying of database 26, and receipt of a current user ID. Content controller 24 again consults the user profile of database 30, step 130, to determine if the current user is authorized for requested application 28, step 140. If the user is authorized, the user is allowed access to application 28, step 150. If the user is not authorized, content controller 24 prevents access to application 28, step 160. Optionally, a message is displayed indicating that the user is not authorized, step 180. Again, an alternative message is envisioned for the case where biometric sensor 20 is unable to perceive biometric data from a user, such as the user not being in the view of camera 21, instructing the user to adjust device 10 to allow capturing of the biometric data.

Accordingly, in the case of the authorized user, the user has obtained device 10, attempted to access device 10, attempted to access application 28, and through a process that is almost completely undetectable to the user, been granted access to application 28.

The authorized user continues use of device 10 by attempting to access application profile 34. One example of an application profile 34 is an e-mail inbox for a specific user. Again, device 10 detects that the user is attempting to access content, step 110. Content controller 24 is again invoked and performs a biometric check, step 120, through a request to recognition module 22, collection of biometric data, querying of database 26, and receipt of a current user ID. Content controller 24 again consults the user profile of database 30, step 130, to determine if the current user is authorized for requested application profile 34, step 140. If the user is authorized, the user is allowed access to application profile 34, step 150. If the user is not authorized, content controller 24 prevents access to application profile 34, step 160. Optionally, a message is displayed indicating that the user is not authorized, step 180. Again, an alternative message is envisioned for the case where biometric sensor 20 is unable to perceive biometric data from a user, such as the user not being in the view of camera 21, instructing the user to adjust device 10 to allow capturing of the biometric data. Additionally, for cases such as those where the user is not authorized for the requested application profile 34, but an application profile 34 exists for which the user is authorized, the authorized application profile 34 is shown to the user instead, step 170. In such cases, a user intentionally or accidentally attempting to access someone else's inbox would be redirected to their own inbox. In cases where the device supports multiple inboxes simultaneously, only those authorized for the currently detected user are presented.

Accordingly, in the case of the authorized user, the user has obtained device 10, attempted to access device 10, attempted to access application 28, attempted to access application profile 34 and through a process that is almost completely undetectable to the user, been granted access to application profile 34.

As the authorized user continues use of device 10, either through application 28 or otherwise, the user continues by attempting to access file content 32. Examples of file content 32 are Word documents, PDF files, images, or any other data files. Again, device 10 detects that the user is attempting to access file content 32, step 110. Content controller 24 is again invoked and performs a biometric check, step 120, through a request to recognition module 22, collection of biometric data, querying of database 26, and receipt of a current user ID. Content controller 24 again consults the user profile of database 30, step 130, to determine if the current user is authorized for requested file content 32, step 140. If the user is authorized, the user is allowed access to file content 32, step 150. If the user is not authorized, content controller 24 prevents access to file content 32, step 160. Optionally, a message is displayed indicating that the user is not authorized, step 180. Again, an alternative message is envisioned for the case where biometric sensor 20 is unable to perceive biometric data from a user, such as the user not being in the view of camera 21, instructing the user to adjust device 10 to allow capturing of the biometric data. In yet another example, applications, such as application stores, require authorization for actions within the application, such as making purchases. In such examples, content controller 24 can be used to seamlessly authorize purchases upon detection of an approved user. Similarly, other payment information and details can be linked to the user profile to allow auto-population of various purchasing forms and authorizations for applications, websites, or the like.

Accordingly, in the case of the authorized user, the user has obtained device 10, attempted to access device 10, possibly attempted to access application 28, attempted to access file content 32 and through a process that is almost completely undetectable to the user, been granted access to file content 32.

From the forgoing, it should be appreciated that secure access is presented at multiple levels without requiring a user to input a password. Furthermore, security checks are conducted upon the attempt to access the content. In use, an authorized user can access a piece of content for which he/she is authorized such that the content is shown on display 14 and then pass the device or otherwise provide such that display 14 is viewable by another, potentially unauthorized user. In that the second unauthorized user has not made a request for the content, no security controllers will have been invoked such that the second user is able to view the content. In this way, a user can share content, such as an e-mail with another.

According to another embodiment, the entire device 14 may be provisioned with profiles. In such an embodiment, a request to access device 10 invokes method 100, which results in allowing access, step 150, but such access is to a specific portion or profile within device 10 rather than the device as a whole. While profiles are discussed as being part of device 10, it should be appreciated that embodiments are envisioned where the profile information is not stored on the device but rather in the cloud or on enterprise servers. Such off-device locations can provide for easy centralized control of biometric and access profiles.

As discussed above, step 120 includes receiving biometric data, analyzing that data and comparing the data to a database of users. Part of receiving biometric data, specifically via camera 21 is to capture an image of user(s) perceiving display 14. Accordingly, an additional feature is to monitor for, warn of, and prevent “over the shoulder” readers. While the user is looking at device 10, camera 21 is looking back at the user. Consequently, camera 21 is able to capture any individual other than the user that is also viewing or attempting to view display 14. Recognition module 22 is able to discern multiple biometric signatures within a single image taken by camera 21. Thus, embodiments are envisioned where presentation of content requires that all detected users have access privileges. Other embodiments are envisioned where upon the detection of multiple users, the highest or lowest security levels are used to determine access.

While the above discussion of access control process 100 discusses allowing access to content step 150 and the step of offering content accessible to the current user, step 170, it should be appreciated that steps 170 and 150 can be combined. Similarly, the process of requesting access to application 28 can be implicitly requesting access to application profile 34. In such embodiments, requesting and invoking application 28, subject to the biometric security access control, automatically invokes application profile 34 for the detected authorized user. Similarly, a request to access device 10 can automatically invoke a device level profile that selectively presents only applications 34 for which the user is authorized.

The above-described device and method provide for a “medium” security model where, as discussed, once content is accessed, it can be shared by allowing other users to view display 14. Embodiments are also envisioned where a “high” security model is employed. Such a “high” security model involves biometric detection during presentation of content. Thus, as opposed to sampling biometric data only upon an access request, the “high” security model continually or periodically samples and verifies that the user(s) is authorized to view the displayed content. The above described device can also be employed to provide a “low” security model. Such a “low” security model provides that only certain applications or content be subject to the biometric verification.

Having described the device and method above, examples are provided below.

### EXAMPLE 1

### Mail Accounts

Device 10 is a tablet capable of accessing multiple email accounts for a family. One account is a general account for the family. A second account is for a personal account of the father. A third account is for a personal account of the mother. Fourth and fifth accounts are business accounts for the father and mother, respectively. When a user attempts to access the email program, device 10 completes a biometric check, and based on the result, provides access to the email accounts as shown in the following table:

| User | Available Accounts |
|---|---|
| Father | General, Father's personal, Father's work |
| Mother | General, Mother's personal, Mother's work |
| Child | General |
| Unknown | General -or- none |

### EXAMPLE 2

### Media or Other File Based Content

Device 10 is a tablet. Device 10 includes preloaded file content 32, specifically video and audio. Device 10 further has access to additional file content 32 stored in the cloud or otherwise. Based on the user as determined by the biometric data, portions of this content are selectively available. Accordingly, users can be screened from age-inappropriate material while allowing similar but age appropriate material to be consumed. Such determinations can be a function of specific permissions linking a user to specific content, where such linking is stored with the content, or user profiles can have flags or indications that indicate larger classes of file content 32 to which the user is availed. File content 32 can thus be categorized into such classes.

### EXAMPLE 3

### Parental Controls

As discussed in Example 2, user profiles can have indications that indicate larger classes of file content 32 to which a user is availed. Accordingly, certain members of a family may be permitted to watch “G” rated content. Other members may be allowed to watch “PG” rated content.

Furthermore, biometric identification can be used to filter access to the entire device. A curfew can be associated with a particular user. If a user subject to a curfew attempts to access the device during a curfew time, such access is permitted. A child is thus prevented from pretending to be asleep while actually having a tablet hidden under the covers and watching a video.

Similarly, the device can keep track of the amount of time each user is using device 10 and use that data to enforce usage limits.

### EXAMPLE 4

### Applications

As previously discussed, permission to run an application is one of the levels of security envisioned by this disclosure. In addition to changing an application profile 34, an application can alter its operation in response to a determination of the user accessing it. One such example includes pre-populating a list of frequently used files or user created files. A second example includes restoring a saved game point specific to the user.

Devices 10 can also be used for applications, such as games or otherwise, where specific users are allowed specific inputs and inputs have differing effects depending on the user who has input them. One such example is in “pass-and-play” games. One user makes a move, such as moving a virtual chess piece. The first user then passes tablet 10 to a second user. Tablet 10 then determines the biometric data of the holder of tablet 10 and upon determining that it is the second user, switches the board perspective and allows the second user to move his/her pieces. Still further, embodiments are envisioned for use where individual users have private game views, such as Scrabble, where each user is privately shown his chosen tiles that are available to play. Such embodiments include access control that prevents users from viewing the private views of other players by using biometric detection to link a player with the correct private view.

Similarly, applications regarding permissions settings and configurations can be restricted to only allow certain users to make changes thereto. The biometric determination can be done independent of user login so that even after a user is logged into a device, the method and apparatus can continue to analyze whether content is being accessed and perform the operations independent of the user login.

The above detailed description and the examples described therein have been presented for the purposes of illustration and description only and not for limitation. For example, the operations described may be done in any suitable manner. The method steps may be done in any suitable order still providing the described operation and results. It is therefore contemplated that the present embodiments cover any and all modifications, variations or equivalents that fall within the spirit and scope of the basic underlying principles disclosed above and claimed herein.

What is claimed is:

1. A method for providing content on a device comprising:
detecting a content request on the device; and
allowing access to the requested content or restricting access to the requested content in response to a visual or audio recognition process that identifies the current access privileges of a current user of the device.

2. The method of claim 1, further comprising identifying a content access profile of the current user in response to identifying the current user of the device based on at least one of a visual and audio recognition process carried out by the device.

3. The method of claim 2, further comprising:
using the content access profile to determine whether the requested content is approved for use by the currently detected user.

4. The method of claim 1, wherein the content request is a request to access the device.

5. The method of claim 1, further including that in response to the content request, it is determined which of a plurality of users is a current user of the device based on at least one of a visual and audio recognition process carried out by the device.

6. The method of claim 5, wherein allowing access to the application configures the application to provide content specific to the current user.

7. The method of claim 1, wherein detecting of the content request is performed independently of a user login event.

8. The method of claim 1, wherein said current user of said device is different from a user logged into said device.

9. A content presentation device including:
a processor;
a display; and
memory; the memory storing software thereon, that when invoked by the processor cause the processor to:
detect a content request on the device; and
allow access to the requested content or restricting access to the requested content in response to a visual or audio recognition process that identifies access privileges of a current user of the device.

10. The device of claim 9, wherein the software, when invoked by the processor, further causes the processor to:
identify a content access profile of the current user in response to identifying which of the plurality of users is the current user of the device based on at least one of a visual and audio recognition process carried out by the device.

11. The device of claim 10, wherein the software, when invoked by the processor, further causes the processor to use the content access profile to determine whether the requested content is approved for use by the currently detected user.

12. The device of claim 9, wherein the content request is a request to access the device.

13. The device of claim 9, wherein the content request is a request to access an application on the device.

14. The device of claim 13, wherein allowing access to the application configures the application to provide content specific to the current user.

15. The device of claim 9, wherein the software further causes the processor to identify, in response to the content request, which of a plurality of users is a current user of the device based on at least one of a visual and audio recognition process carried out by the device.

16. The device of claim 9, wherein detection of the content request is performed independently of a user login event.

17. The device of claim 9, wherein said current user of said device is different from a user logged into said device.

18. A method for providing content on a device comprising:
logging a first user into the device;
post log-in of the first user, and in response to a request for content, performing at least one of a visual or audio recognition process on a current user of the device; and
preventing displaying of the content on the device in response to determining that the current user is different from the first user, the determining being based on the post-log-in visual or audio recognition process performed on the current user of the device.

19. The method of claim 18, further including displaying of content other than the requested content in response to the request for content.

20. The method of claim 18, further including determining a content access profile of the current user based on at least one of a visual and audio recognition process carried out by the device.

21. The method of claim 20, wherein the content access profile indicates that the requested content should not be displayed to the current user.

22. The method of claim 18, wherein content request is a request to access the device.

23. The method of claim 18, wherein the content request is a request to access an application on the device.

24. The method of claim 18, wherein the at least one of a visual or audio recognition process is performed via a user recognition module that accesses a database of user signatures.

25. The method of claim 24, wherein the user recognition module provides a user ID and the user ID is used with a user profile associated with the user ID to determine that the requested content should not be displayed to the current user.

26. A computer readable medium having non-transitory instructions thereon, that when interpreted by a processor, cause the processor to:
detect a content request on the device; and
allow access to the requested content or restrict access to the requested content in response to a visual or audio recognition process that identifies the current access privileges of a current user of the device.

27. The computer readable medium of claim 1, wherein the instructions further cause the processor to identify a content access profile of the current user in response to identifying the current user of the device based on at least one of a visual and audio recognition process carried out by the device.

28. The computer readable medium of claim 27, wherein the instructions further cause the processor to use the content access profile to determine whether the requested content is approved for use by the currently detected user.

29. The computer readable medium of claim 27, wherein the content request is a request to access the device.

30. The computer readable medium of claim 27, wherein the instructions further cause the processor to, in response to the content request, determine which of a plurality of users is a current user of the device based on at least one of a visual and audio recognition process carried out by the device.

31. The computer readable medium of claim 30, wherein allowing access to the application configures the application to provide content specific to the current user.

32. The computer readable medium of claim 27, wherein detecting of the content request is performed independently of a user login event.

33. The computer readable medium of claim 27, wherein said current user of said device is different from a user logged into said device.
